(19) United States
(12) Patent Application Publication
(10) Pub. No.: US 2009/0104373 A1
(43) Pub. Date: Apr. 23, 2009

(54) METHODS FOR APPLYING FLUORESCENT ULTRAVIOLET CURABLE VARNISHES

(75) Inventors: Daryl W. VANBESIEN, Burlington (CA); Gabriel IFTIME, Mississauga (CA); Gordon SISLER, St. Catharines (CA); Kurt I. HALFYARD, Mississauga (CA); Jordan WOSNICK, Toronto (CA); T. Brian MCANENEY, Burlington (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 11/877,319

(22) Filed: Oct. 23, 2007

(51) Int. Cl. C08J 7/18

(52) U.S. Cl. 427/553; 427/157

(57) ABSTRACT

Disclosed is methods for applying a radiation curable fluorescent varnish to a document and authenticating the document via the radiation curable fluorescent varnish. The ultraviolet radiation curable fluorescent varnish comprising at least one curable monomer or oligomer, at least one photoinitiator, and at least one fluorescent material, wherein upon exposure to activating radiation, the fluorescent material fluoresces to cause a visible change in the appearance of the ultraviolet radiation curable fluorescent varnish. The methods include determining a location of printed portions of an image on a substrate and digitally printing the ultraviolet radiation curable fluorescent varnish onto the substrate in image registration only upon one or more portions of the determined printed portions on the substrate.

### BACKGROUND

Described herein are ultraviolet radiation curable varnishes (UV curable varnish) containing a fluorescent component that may be used in an image forming device to print transient information on an image receiving substrate (substrate) or document.

In embodiments, the UV curable varnish may be applied as an overcoating to one or more portions of corresponding underlying text or image of a substrate via a digital overcoating system. The UV curable varnish may be used in place of or with a non-fluorescent ink, thereby permitting the formation characters of text and/or one or more images on the substrate or document using a known digital overcoating system. In embodiments, UV curable varnish may be overcoated or overprinted over characters, text and/or an image or a portion of characters, text and/or an image formed by other non-fluorescent inks, so as to have a size, shape and configuration that is the same as or substantially similar to the size, shape and configuration of the characters, text, and/or the image or a portion thereof.

U.S. application Ser. No. 11/548,774 (U.S. '774) discloses a radiation curable ink containing a fluorescent material that upon exposure to activating energy fluoresces such that an image that was not visible prior to exposure to the activating energy becomes visible. U.S. '774 also discloses an ink jet system and a process for printing the radiation curable ink. The radiation curable ink is applied to a portion of or an entire surface of a substrate via spot coating or flood coating techniques to form the image with the radiation curable ink on the portion of or the entire surface of the substrate. The radiation curable ink of U.S. '774 is applied onto the surface of the substrate without regard for an image-on-image relationship of the underlying text.

### SUMMARY

In embodiments, disclosed herein is a method for applying varnish to a document, the method includes providing an ultraviolet radiation curable fluorescent varnish comprising at least one curable monomer or oligomer, at least one photoinitiator, and at least one fluorescent material, wherein upon exposure to activating radiation, the fluorescent material fluoresces to cause a visible change in the appearance of the ultraviolet radiation curable fluorescent varnish. Moreover, the method includes determining a location of printed portions of an image on a substrate and digitally printing the ultraviolet radiation curable fluorescent varnish onto the substrate in image registration only upon one or more portions of the determined printed portions on the substrate.

In further embodiments, disclosed is a method for applying varnish to a document, the method includes providing an ultraviolet radiation curable fluorescent varnish comprising at least one curable monomer or oligomer, at least one photoinitiator, and at least one fluorescent material, wherein upon exposure to activating radiation, the fluorescent material fluoresces to cause a visible change in the appearance of the ultraviolet radiation curable fluorescent varnish. Further, the method includes determining a location of printed portions of an image on a substrate based on information, wherein the location of the printed portions of the image is determined based on printing information for the image on the substrate, information from copying the image on the substrate or information from scanning the substrate. Moreover, the method includes digitally printing the ultraviolet radiation curable fluorescent varnish onto the substrate in image registration only upon one or more portions of the determined printed portions on the substrate.

In yet further embodiments, disclosed is a method for authenticating a document, the method includes forming the document by forming an image on a surface of a substrate, determining location of printed portions of the image on a substrate, and applying and curing an ultraviolet radiation curable fluorescent varnish onto the substrate in image registration only upon one or more portions of the detected image on the substrate. The ultraviolet radiation curable fluorescent varnish comprising at least one curable monomer or oligomer, at least one photoinitiator, and at least one fluorescent material, wherein upon exposure to activating radiation, the fluorescent material fluoresces to cause a visible change in the appearance of the ultraviolet radiation curable fluorescent varnish. The method includes exposing the document to the activating radiation, wherein the document is determined to be authentic if the exposing results in fluorescing of the ultraviolet radiation curable fluorescent varnish at the overcoated locations.

### EMBODIMENTS

Described herein are UV curable varnishes containing a fluorescent component that fluoresces upon exposure to UV radiation. The UV curable varnish is selectively applied only to text, a portion of text, an image or a portion of an image on a substrate or document by a digital printing system so as to be in image registration with all or a part of the underlying portions of text or characters. Image registration refers to, for example, the varnish being located substantially identically over the text or character with minimal, if any, overcoat onto surrounding non-printed portions of the substrate adjacent the text or character, and thus substantially matching.

In these ways, the presence of the UV overcoat is extremely difficult to detect as it is present only over previously printed text or characters. Further, authentication can be obtained at low cost as less varnish is used in the overcoat with this selective overcoating.

The fluorescent component of the UV curable varnish disclosed herein thus may be digitally overcoated onto one or more portions of corresponding underlying printed characters, text, one or more portions of the text, an image or a portion of the image (collectively known hereinafter as “images”) without overcoating onto surrounding adjacent non-printed portions of the substrate adjacent to the images. As a result, the images formed using the UV curable varnish fluoresce upon exposure to ultraviolet (UV) radiation without the UV curable varnish being applied onto surrounding non-printed portions of the substrate adjacent to the images. The fluorescent property of the UV curable varnish disclosed herein may be useful in security applications for document authentication to prevent document fraud or counterfeiting. The fluorescent component of the UV curable varnish oil the document may not be noticeable to a viewer when viewed in ambient light, but becomes noticeable when exposed to UV radiation at which the fluorescent composition on the document fluoresces. Upon removal of the document from exposure to UV radiation, the fluorescent composition on the document desirably returns to a non-fluorescent state. Such a fluorescent property is useful in authentication of the document, as a forged or counterfeited document or photocopy of the document would not have the ability to fluoresce and change appearance upon exposure to UV radiation.

The TV curable varnish having a fluorescent component provides a security feature that may be imbedded in the document and/or that may contain authentication information which can appear and disappear in a controlled manner via exposure to UV radiation. If the document is forged, for example by photocopying the document, the authentication information provided by the fluorescent component in the UV curable varnish, even if visible, cannot be made to appear and disappear in a manner controllable by exposure to UV radiation. As a result, a viewer of the authentic document may authenticate the document by exposing the document to UV radiation to cause the fluorescence.

Advantages of overcoating or overprinting characters, text, an image or a portion of an image formed by non-fluorescent material with a colorless UV curable varnish having the fluorescent composition may include making images, texts, and the like that appear normal in ambient light, but which are noticeably altered in appearance to fluoresce upon exposure to UV radiation. When images, texts, and the like are printed onto a document with the colorless UV curable varnish having the fluorescent composition are photocopied, the image, text, and the like will not be visible in the photocopy of the document. This is because the fluorescent composition in the UV curable varnish does not fluoresce under existing copying conditions for the document, and thus will not appear in the photocopy of the document. Moreover, the copy of the document will not contain the UV curable varnish with fluorescent composition, so that the copy of the document will not fluoresce via exposure to UV radiation. Such a security feature of the UV curable varnish is advantageous in preventing a falsified, fraudulent or counterfeited photocopy of the document from including the fluorescent component. Moreover, this security feature can permit one to intentionally embed authentication information in a document so that such authentication information may only be revealed to a viewer that knows to expose the document or a portion of the document to UV radiation to view the authentication information.

The UV curable varnish may be cured to form a colorless varnish on the substrate or document. In embodiments, the UV curable varnish may be non-colorless to form different color effects for the overprinted characters, text, one or more portions of character or text, image or a portion of an image (collectively known hereinafter as “images”). In embodiments, the UV curable varnish may be a post-finishing overcoat varnish that may be applied to the substrate or document via a digital printing system.

In a digital printing system, the UV curable varnish may be selectively applied to one or more predetermined or selected locations on the substrate or document. With a digitally applied varnish, the UV curable varnish can produce effects, such as a differential gloss in patterned or non-patterned arrays, that are incapable of being photocopied. As a result, the digitally applied varnish is an overcoat varnish on the images, or as color enhancement onto the images.

The UV curable varnish applied or overcoated to non-fluorescent images may provide, for example image permanence, thermal stability, lightfastness, and smear resistance for the images that are overcoated with the UV curable varnish. As a result, the UV curable varnish may prevent or reduce damage to or wear to non-fluorescent images that are overcoated by the UV curable vanish. Additionally, the fluorescent component of the UV curable varnish provides a security feature for the document to authenticate the document and prevent fraud and/or counterfeiting of the document.

As the UV curable varnish is exposed to UV radiation, the fluorescent component of the UV curable varnish may fluoresce and/or become visible to authenticate the document. When exposure to the UV radiation is terminated, fluorescing of the fluorescent component desirably also terminates and the UV curable varnish becomes clear and/or invisible and the fluorescent component may disappear. If the document was to be forged by, for example, photocopying the document, the duplicate of the document would not contain the fluorescent component of the UV curable varnish, would not fluoresce by exposure to UV radiation, and would be identifiable as a fraudulent or counterfeit document by failing to display the fluorescent component during exposure to UV radiation.

The UV curable varnish may be positioned at a specified or desired location by digitally printing the UV curable varnish onto a specified or desired location of the document. As a result, the UV curable varnish may be digitally printed at the specified or desired location to prevent detection of the fluorescent component by a viewer that may not be aware of the positioning or location of the UV curable varnish and/or fluorescent component thereon. A viewer of the document may not be aware of the positioning or location of the UV curable varnish on the document so to further prevent a viewer from identifying the fluorescent component and/or from forging or counterfeiting the document by positioning the fluorescent component of the UV curable varnish at the specified or desired location.

The underlying images may be formed or printed with toner or ink onto the document via a digital printing or digital copying machine. As a result, the document displays pre-existing or prior printed images. In a digital printing or copying machine, a digital electrophotographic method for forming the images may provide both high speed printing and high image quality images. In the digital electrophotographic method, a light beam which is adjusted to a predetermined spot diameter in an image optical system is used for scanning of a photosensitive member. A latent image in an area modulation mode which corresponds to an image density signal is formed on the photosensitive member. The area modulation is modulated by an ON/OFF time duration of the light beam corresponding to the image density signal determined by a pulse duration modulation means. The latent image is visualized by a toner to form a toner image and image forming is thus completed by transferring the toner image to the substrate or document.

A process for forming the images in which a toner image is formed is not limited to electrophotography, but the process may be a process in which a toner is transferred directly onto a toner image carrier according to image data received via digital processing and thereafter a toner image is formed on the toner image carrier. The toner image is transferred to the substrate or document and the image forming is completed.

The image forming process may also be a process in which a magnetic latent image is formed on a toner image carrier according to an image data received via digital processing and the toner image is formed according to the magnetic image on the toner image carrier. The image forming is completed as the toner image is transferred onto the substrate or document.

The image forming process may also be a process in which an electrostatic latent image is formed by writing a charge image directly on a toner image carrier according to an image data received via digital processing. The toner image is thereafter formed on the toner image carrier according to the electrostatic latent image. The toner image thus formed on the toner image carrier is temporarily transferred on an intermediate transfer member and subsequently, the toner image is further transferred onto the substrate or document for simultaneous transfer and/or fixing to complete the image forming.

The image forming process typically employs an initial step of charging a photoconductive member to a substantially uniform potential and thereafter exposing the photoconductive member to record the latent image. A print engine in the image forming system has at least four developer stations. Each developer station has a corresponding developer structure. Each developer structure may contain one of magenta, yellow, cyan or black toner. The print engine may include additional developer stations having developer structures containing other types of toner such as MICR (magnetic ink character recognition) toner. The print engine may also include one, two or three developer structures having one, two or three different types of toner, respectively. Each of the developer stations may be preceded by an exposure process. Further, each of the developer stations may include a corresponding dispenser for supplying toner particles to the developer structure. Each developer station may apply a different type of toner to the latent image.

Upon completion of the image forming, the images are transferred and formed on the substrate or document. The images may be fixed to the substrate or document via a toner fixing process or mechanism to prevent the toner from being separated from or removed from the substrate or document. As a result of the image forming process, pre-existing or prior printed images may be formed on the substrate or document.

UV curable varnishes may be used to emphasize graphical elements in a document by applying the UV curable varnishes to all or portions of pre-existing or prior printed images in image registration. The UV curable varnish may be colorless and have the same gloss as the pre-existing or prior printed images to provide a non-detectable fluorescent component on the pre-existing or prior printed images. With these properties, the substantially clear or colorless UV curable varnish does not adversely affect the appearance of the visible pre-existing or prior printed images because the gloss of the pre-existing or prior printed images formed from the non-fluorescent ink and the gloss formed by the UV curable varnish are similar. The change between the fluorescing state and the non-fluorescing state of a colored or a colorless UV curable varnish can be repeated an indefinite number of times, and for example from about 10 to about 100,000,000 times or more.

The UV curable varnish may be made to exhibit substantially the same gloss upon printing. As such, an advantage herein is that the differential gloss realized when overcoating a pre-existing or prior printed images with a conventional clear overcoat or ink may be avoided. Gloss is a measure of an image's shininess, which should be measured after the image has been formed on a print sheet. Gloss may be measured using a Gardiner Gloss metering unit. In embodiments herein, inks used in an ink set and the UV curable varnish are made to have substantially matched gloss. In this regard, each of the inks and the UV curable varnish may have a gloss within about 5 Gardiner gloss units (ggu) of each other, for example a gloss value within from 0 to about 5 ggus or from about 0.5 to about 3 ggus or from about 0.5 to about 2 ggus, of each other. In doing so, the pre-existing or prior printed images that may be overprinted or overcoated by the UV curable varnish may have capabilities that exhibit substantially no differential gloss, and thus the appearance of the image is uniform.

If gloss differential is not desired, to increase the viscosity before and/or after jetting, and thereby reduce the differential gloss, the UV curable varnish may optionally include a gellant. For example, suitable gellants include a curable gellant comprised of a curable polyamide-epoxy acrylate component and a polyamide component, a curable composite gellant comprised of a curable epoxy resin and a polyamide resin, amide gellants and the like. In embodiments, suitable curable composite gellants may include a curable epoxy, a polyamide resin and a curable polyamide-epoxy acrylate resin.

The UV curable varnish may include the gellant in any suitable amount, such as about 1% to about 50% by weight of the UV curable varnish. In embodiments, the gellant can be present in an amount of about 2% to about 20% by weight of the UV curable varnish, such as about 5% to about 15% by weight of the UV curable varnish, although the value can also be outside of this range.

Alternatively, the UV curable varnish may provide an increased gloss to the pre-existing or prior printed images to added visual impact or enhancement varnish via the increased gloss of the document. In embodiments, the UV curable varnish may be have a color that is different than the color of the pre-existing or prior printed images to provide a different color effect when exposed to UV radiation.

In embodiments, the colored UV curable varnish may be of a color, for example cyan, magenta, yellow or black. The fluorescent component of the UV curable varnish may be in a colored UV curable varnish having a color that does not mask fluorescing upon exposure to UV radiation. For example, fluorescence, manifested as a color change or appearance change of the color image, may be more readily apparent when the fluorescent component is included in a lighter shade colored UV curable varnish such as yellow or magenta. Fluorescence might not be noticeable in a very dark UV curable varnish such as black.

The fluorescent component may exhibit a color even when viewed in ambient light. When exposed to UV radiation, the fluorescent component fluoresces a color which may be the same or different from the color displayed in ambient light. A change in the appearance of the UV curable varnish is visible due to fluorescence of the fluorescent composition upon exposure to UV radiation.

The fluorescent composition may be included in a colored UV curable varnish such that the UV curable varnish is colored when viewed in ambient light, and the fluorescent component fluoresces a different color or the same color when exposed to UV radiation.

When the UV curable varnish is colored, the fluorescent component of the UV curable varnish noticeably alters the appearance of the pre-existing or prior printed images upon exposure to radiation. In ambient light, the digitally printed UV curable varnish will exhibit the intended color of the non-fluorescent colorant in the UV curable varnish. However, upon exposure to radiation, fluorescence of the fluorescent component in the UV curable varnish changes the color exhibited by the UV curable varnish. For example, a yellow fluorescent UV curable varnish exhibits the intended yellow color in ambient light, but upon exposure to UV radiation, the fluorescence of the fluorescent component changes the color exhibited to a different color, for example to a red color.

The colored fluorescent component may be included in a colored UV curable varnish. In such embodiments, the resulting color in ambient light is a combination of the colors of the fluorescent component and the colored non fluorescent component. When exposed to UV radiation, the color is substantially changed due to the fluorescence emission of the fluorescent component.

Color refers to, for example, the overall absorption characteristic within the same range of wavelengths of the electromagnetic spectrum. Thus, differently colored varnishes exhibit a color, that is, an absorption characteristic, different from each other. For example, if a first varnish exhibits a yellow color, then a second differently colored varnish will exhibit a different shade of yellow or a different color altogether, for example such as cyan or magenta.

Suitable colored fluorescent components, which are colored in ambient light and which fluoresce when exposed to the activating energy, may include for example dyes such as DFWB-K41-80 that is red in ambient light and that fluoresces red-purple under UV light and DFSB-K401 that is red-purple in ambient light and that fluoresces red-purple under UV light, each of which is available from Risk Reactor. Other examples include DFSB-K400 that has a brown appearance in ambient light and that fluoresces orange under excitation with UV light, DFSB-K427 that is orange under ambient light and under exposure to UV light, and DFSB-K43 that is yellow in ambient light and under exposure to activating UV light.

UV curable varnishes may also contain at least one non-fluorescent colorant. As used herein “colorant” includes pigment, dye, mixtures of dyes, mixtures of pigments, mixtures of dyes and pigments, and the like. The non-fluorescent colorant may be present in a colored varnish in any desired amount, for example from about 0.5 to about 75 percent by weight of the varnish, for example from about 1 to about 50 percent by weight of the varnish.

Examples of suitable non-fluorescent colorants include pigments, dyes, mixtures of pigments and dyes, mixtures of pigments, mixtures of dyes, and the like. Any dye or pigment may be chosen, provided that it is capable of being dispersed or dissolved in the varnish and is compatible with the other varnish components. Examples of suitable pigments include, but are not limited to, Violet PALIOGEN Violet 5100 (BASF); PALIOGEN Violet 5890 (BASF); HELIOGEN Green L8730 (BASF); LITHOL Scarlet D3700 (BASF); Sunfast® Blue 15:4 (Sun Chemical 249-0592); Hostaperm Blue B2G-D (Clariant); Permanent Red P-F7RK; Hostaperm Violet BL (Clariant); LITHOL Scarlet 4440 (BASF); Bon Red C (Dominion Color Company); ORACET Pink RF (Ciba); PALIOGEN Red 3871 K (BASF); Sunfast® Blue 15:3 (Sun Chemical 249-1284); PALIOGEN Red 3340 (BASF); Sunfast® Carbazole Violet 23 (Sun Chemical 246-1670); LITHOL Fast Scarlet L4300 (BASF); Sunbrite Yellow 17 (Sun Chemical 275-0023); HELIOGEN Blue L6900, L7020 (BASF); Sunbrite Yellow 74 (Sun Chemical 272-0558); Spectra Pac® C Orange 16 (Sun Chemical 276-3016); HELIOGEN Blue K6902, K6910 (BASF); Sunfast® Magenta 122 (Sun Chemical 228-0013); HELIOGEN Blue D6840, D7080 (BASF); Sudan Blue OS (BASF); NEOPEN Blue FF4012 (BASF); PV Fast Blue B2GO1 (Clariant); IRGALITE Blue BCA (Ciba); PALIOGEN Blue 6470 (BASF); Sudan Orange G (Aldrich), Sudan Orange 220 (BASF); PALTOGEN Orange 3040 (BASF); PALIOGEN Yellow 152, 1560 (BASF); LITHOL Fast Yellow 0991 K (BASF); PALIOTOL Yellow 1840 (BASF); NOVOPERM Yellow FGL (Clariant); Lumogen Yellow D0790 (BASF); Suco-Yellow L1250 (BASF); Suco-Yellow D1355 (BASF); Suco Fast Yellow D1355, D1351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT), PALIOGEN Black L0084 (BASF); Pigment Black K801 (BASF); and carbon blacks such as REGAL 330™ (Cabot), Carbon Black 5250, Carbon Black 5750 (Columbia Chemical), mixtures thereof and the like. Examples of suitable dyes include Usharect Blue 86 (Direct Blue 86), available from Usbianti Color; Intralite Turquoise 8GL (Direct Blue 86), available from Classic Dyestuffs; Chemictive Brilliant Red 7BH (Reactive Red 4), available from Chemiequip; Levafix Black EB, available from Bayer; Reactron Red H8B (Reactive Red 31), available from Atlas Dye-Chem; D&C Red #28 (Acid Red 92), available from Wamer-Jenkinson; Direct Brilliant Pink B, available from Global Colors; Acid Tartrazine, available from Metrochem Industries; Cartasol Yellow 6GF Clariant; Carta Blue 2GL, available from Clariant; and the like.

In embodiments, solvent dyes are employed. An example of a solvent dye suitable for use herein may include spirit soluble dyes because of their compatibility with the varnish disclosed herein. Examples of suitable spirit solvent dyes include Neozapon Red 492 (BASF); Orasol Red G (Ciba); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow CGP (Ciba); Orasol Black RLP (Ciba); Savinyl Black RLS (Clariant); Morfast Black Conc. A (Rohm and Haas); Orasol Blue GN (Ciba); Savinyl Blue GLS (Sandoz); Luxol Fast Blue MBSN (Pylarn); Sevron Blue 5GMF (Classic Dyestuffs); Basacid Blue 750 (BASF), Neozapon Black X51 [C.I. Solvent Black, C.I. 12195] (BASF), Sudan Blue 670 [C.I. 61554] (BASF), Sudan Yellow 146 [C.I. 12700] (BASF), Sudan Red 462 [C.I. 260501] (BASF), mixtures thereof and the like.

By overcoating UV curable varnish onto pre-existing or prior printed images, the UV curable varnish can be used to accent the pre-existing or prior printed images. The UV curable vanish may protect the pre-existing or prior printed images by providing, for example, an additional covering which protects the pre-existing or prior printed images from scuffing and the like. In addition, the UV curable varnish may, for example, draw a viewer's eyes to particular pre-existing or prior printed images and to add depth and interest to the pre-existing or prior printed images. It should be understood that the term overcoating is intended to encompass all overcoating systems and processes including UV curable varnishes, and/or any other overcoating process type that may result.

In embodiments, the pre-existing or prior printed images may be detected to determine the specific location of the pre-existing or prior printed images. When the specific location of the pre-existing or prior printed images has been determined, the UV curable varnish may be digitally printed onto the pre-existing or prior printed images to provide an overcoating varnish with a fluorescent component. As a result, the UV curable varnish may not be printed onto non-printed portions of the document.

The specific location of the pre-existing or prior printed images being overcoated with the UV curable varnish may be determined by any suitable procedure. For example, the location of the images to be specifically overprinted with the UV curable varnish may be based on the printing information that was utilized to digitally print the underlying pre-existing or prior printed images on the document. The UV curable varnish may be applied to the document at all or part of the specific locations of the pre-existing or prior printed images in accordance with the printing information for the pre-existing or prior printed images. Alternatively, in embodiments, the document having the pre-existing or prior printed images may be copied or scanned to identify the specific locations of the pre-existing or prior printed images on the document. When the specific location of the pre-existing or prior printed images are determined via copying or scanning, the UV curable varnish may be applied to the document at all or part of the specific location of the pre-existing or prior printed images to provide an overcoat varnish substantially without applying the UV curable varnish to any of adjacent non-printed portions of the image.

Accordingly, the exemplary techniques described herein may be utilized with any application utilizing a overcoating. For example, a web offset press or sheet lithographic press that includes a digital overcoating system that utilizes the technology to apply UV curable varnishes may employ this technology described herein to gradually produce overcoated/non-overcoated boundaries.

The methods and systems as described above may be, for example, used in the application of any digital printing or digital overcoating system that utilizes overcoatings.

The UV curable varnish formulations herein include at least one curable monomer or oligomer, at least one photoinitiator and a fluorescent compound.

Examples of curable monomers used in the UV curable varnish include propoxylated neopentyl glycol diacrylate, diethylene glycol diacrylate, triethylene glycol diacrylate, hexanediol diacrylate, dipropyleneglycol diacrylate, tripropylene glycol diacrylate, alkoxylated neopentyl glycol diacrylate, isodecyl acrylate, tridecyl acrylate, isobomyl acrylate, propoxylated trimethylolpropane triacrylate, ethoxylated trimethylolpropane triacrylate, di-trimethylolpropane tetracarylate, dipentaerythritol pentacarylate, ethoxylated pentaerythritol tetraacrylate, isobomyl methacrylate, lauryl acrylate, lauryl methacrylate, isodecylmethacrylate, caprolactone acrylate, 2-phenoxyethyl acrylate, isooctylacrylate, isooctylmethacrylate, butyl acrylate, unsaturated polyether acrylate, propoxylated-2-neopentyl glycol diacrylate, amine modified polyester tertracrylate, amine modified polyester acrylate mixtures thereof and the like.

Common oligomers that may be used in the composition of the UV curable varnish include oligomers produced by Sartomer Company, BASF, Cognis Corporation, Cytec Industries Inc. (formerly UCB Surface Specialties), Rahn. There are three major classes of oligomeric acrylates: epoxy, polyester and polyurethane. These oligomers include LAROMER® PO43F (BASF Corp.), SR-9003 (Sartomer Co., Inc.), EB80 and/or EB81(Cytec Surface Specialities) and EBECRYL 812 (ex Cytec Industries Inc., formerly UCB); PO 83 F, P094 F, and PO 33 F ex BASF; PHOTOMER 4967 and PHOTOMER 5429 ex Cognis; CN292, CN2204, CN131B, CN984, CN2300, CN549, CN501, CN2279, CN2284, CN2270 and CN384 ex SARTOMER; GENOMER 3364 and Genomer 3497 ex Rahn, mixtures thereof and the like. Monomers and oligomers may also be mixed. The UV curable varnish may also include additional polymeric components, as desired.

The curable monomer or oligomer in embodiments may be included in the UV curable varnish in an amount of, for example, about 20 to about 90% by weight of the UV curable varnish, such as about 30 to about 85% by weight of the UV curable varnish, or about 40 to about 80% by weight of the UV curable varnish.

Examples of photoinitiators used in the composition of the UV curable varnish may include IRGACURE® 184 (CIBA-GEIGY) also known as 1-hydroxy-cyclohexylphenylketone, LUCMRIN® TPO-L (BASF Corp.) also known as ethyl-2,4,-6-trimetlhylbenzoylphenylphosphinate, benzophenone, 2-benzyl-2-(dimethylamino)-1-(4-(4-morphorlinyl)phenyl)-1-butanone, 2-methyl-1-(4-methylthio)phenyl-2-(4-morphorlinyl)-1-propanone, diphenyl-(2,4,6-triniiethylbenzoyl) phospinie oxide, phenyl bis(2,4,6-trimethylbenizoyl) phosphine oxide, benzyl-dimethylketal, isopropylthioxanthone, mixtures thereof and the like. This list is not exhaustive; any known photoinitiator that can be used in the composition of a UV curable varnish may be used.

Often, several photoinitiators are used to efficiently harvest the light energy supplied by the UV light source. For instance, the phosphine oxide class of photoinitiators, such as diphenyl-(2,4,6-trimethylbenzoyl) phospine oxide, are known to be very light sensitive and absorb at longer wavelengths of light, for example, up to about 400 nm. These properties make this class of photoinitiators useful in pigmented inks because they absorb light where pigments often have little absorption (˜400 nm) and their sensitivity allows these photoinitiators to initiate polymerization deep in a pigmented varnish where little light has penetrated. Initiators with these properties are thus said to be useful for depth cure. However, the phosphine oxides do not efficiently initiate polymerizations in the presence of oxygen. Oxygen is known to interfere with free radical reactions. UV curing systems typically have sufficiently high levels of photoinitiator that there is enough to consume the oxygen present and initiate the polymerization. The difficulty arises when fresh oxygen can diffuse to the active free radical polymerization and slow or stop it. These conditions are most likely to occur at the surface of ink or coating when the irradiation takes place in air.

Other photoinitiator systems may be used to overcome the presence of higher levels of oxygen near the surface of the coating. Examples of photoinitiators that function well near the surface are 2-methyl-1-(4-methylthio)phenyl-2-(4-morphorlinyl)-1-propanone or the combination of isopropylthioxanthone or benzophienone and a suitable amine functionality such as the oligomer PO94 F from BASF or small molecule amines such as ethyl 4-(dimethylamino)benzoate. Such photoinitiators systems as these are said to be effective for surface curing.

The photoinitiators initiate the polymerization of activated carbon-carbon double bonds to form chains of single bonds. Activation of carbon-carbon double bonds to free radical polymerization is generally achieved through conjugation with other double bonds such as occurs with acrylate, methacrylate and styrenic groups. Styrene derivatives often have other photochemical pathways available to them that interfere with the desired polymerization or curing of the ink.

Methacrylate groups offer good mechanical properties upon cure but are typically slower to polymerize than acrylate groups. Thus, for rapidly curing inks for use in high speed printers, acrylate functionality may be the predominate type of reactive group. The monomers and oligomers may be chosen to provide good properties upon cure, rapid polymerization, low viscosity for jetting, and safe handling.

The total amount of initiator included in the UV curable varnish may be, for example, from about 0.5 to about 15%, such as from about 1 to about 10%, by weight of the UV curable varnish.

Fluorescent component refers to, for example, the capability of a material or the varnish to fluoresce upon exposure to an activating radiation, for example a radiation source having a wavelength in the UV region, such as a wavelength from about 100 nm to about 400 nm or from about 200 nm to about 380 nm. To stop the fluorescence, exposure to UV radiation may be discontinued. Once the exposure UV radiation is discontinued, the fluorescence ceases and the UV curable varnish returns to its original state. In other words, when the radiation is discontinued, the fluorescent image displayable via the UV curable varnish is no longer visible to the naked eye.

In embodiments, the fluorescent component may be loaded in an amount of from about 0.01% to about 10% by weight, for example about 0.5% to about 5% by weight, of the UV curable varnish without adversely affecting the curability of the UV curable varnish. In embodiments, the UV curable varnish may be applied to a document via digital printing or digital overcoating to produce fluorescent patterns on the document which will be visible during exposure to UV radiation.

The fluorescing may occur instantaneously on exposure to the UV radiation, or may occur after overcoming any activation phase. The fluorescing exhibited by the fluorescent component is reversible, but should last for a time period permitting the color change or image appearance to be detected, for example a time frame of from about 0.5 seconds to about 1 hour, such as from about 1 second to about 45 minutes or from about 5 seconds to about 30 minutes.

Suitable fluorescent components may include fluorescent dyes, fluorescent pigments and inorganic surface functionalized quantum dot materials. Examples of fluorescent dyes suitable for use herein include those belonging to the dye families known as rhodamines, fluoresciens, coumarine, napthalimides, benzoxanthenes, acridines, azos, mixtures thereof and the like. Suitable fluorescent dyes include, for example, Basic Yellow 40, Basic Red 1, Basic Violet 11, Basic Violet 10, Basic Violet 16, Acid Yellow 73, Acid Yellow 184, Acid Red 50, Acid Red 52, Solvent Yellow 44, Solvent Yellow 131, Solvent Yellow 85, Solvent Yellow 135, solvent Yellow 43, Solvent Yellow 160, Fluorescent Brightner 61, mixtures thereof and the like. Other suitable fluorescent dyes include oil and solvent based dyes like DFSB class, DFPD class, DFSB-K class available from Risk reactor of Huntington Beach, Calif. Suitable fluorescent pigments include, but are not limited to, those available from Day-Glo Color Corp. of Cleveland, Ohio, such as aurora pink T-11 and GT-11, neon red T-12, rocket red T-13 or GT-13, fire orange T-14 or GT-14N, blaze orange T-15 or GT-15N, are yellow T-16, saturn yellow T-17N, corona magenta GT-21 and GT-17N, mixtures thereof and the like. Other suitable fluorescent pigments available from Risk Reactor are for example PFC class, like for example PFC-03 which switches from invisible to red when exposed to UV light, PF class like for example PF-09 which switches from invisible to violet when exposed to UV light. Other suppliers of fluorescent materials include Beaver Luminescers from Newton, Mass. and Cleveland Pigment & Color Co. from Akron, Ohio.

Quantum dot materials are fluorescent inorganic semiconductor nanoparticle materials. The light emission of quantum dots is due to quantum confinement of electrons and holes. An advantage of quantum dots is that they can be tuned so that they emit any desired wavelength (color) as a function of their size, by using one material only and the same synthetic process. For example in a range comprised from about 2 to about 10 nm, one can obtain a full range of colors from the visible range of the spectrum. In addition, quantum dots possess improved fatigue resistance when compared with organic dyes. Another advantage of quantum dots is their narrow emission bands, which increases the number of possible wavelength choices for designing customized colors. Due to their small size, typically less than about 30 nm, such as less than about 20 nm, they can be easily ink jetted. Quantum dots are available from a variety of companies, such as from Evident Technologies (Troy, N.Y.).

In embodiments, the quantum dot materials used herein are functionalized quantum dots. Surface functionalized quantum dots may have better compatibility with radiation curable ink materials. Suitable functional groups present on the surface of the nanoparticle quantum dots for compatibility with radiation curable ink include long linear or branched alkyl groups, for example from about 1 carbon atom to about 150 carbon atoms in length, such as from about 2 carbon atoms to about 125 carbon atoms or from about 3 carbon atoms to about 100 carbon atoms. Other suitable compatible groups include polyesters, polyethers, polyamides, polycarbonates and the like.

The UV curable varnish formulation disclosed herein may also comprise at least one optional curable wax. The optional curable wax may be any wax component that is miscible with the other components and that will polymerize with the curable monomer or oligomer to form a polymer. The term “wax” includes, for example, any of the various natural, modified natural, and synthetic materials commonly referred to as waxes. A wax is solid at room temperature, specifically at 25° C. Inclusion of the wax promotes an increase in viscosity of the varnish as it cools from the jetting temperature.

The optional curable wax can be included in the UV curable varnish in an amount of from, for example, about 1 to about 25% by weight of the UV curable varnish, such as about 2 or about 5 to about 10 or about 15% by weight of the UV curable varnish. In an embodiment, the curable wax can be included in the UV curable varnish in an amount of from about 6 to about 10% by weight of the UV curable vanish, such as about 8 to about 9% by weight of the UV curable varnish.

Suitable examples of curable waxes include, but are not limited to, those waxes that include or are functionalized with curable groups. The curable groups may include, for example, acrylate, methacrylate, alkene, allylic ether, epoxide, oxetane, and the like. These waxes can be synthesized by the reaction of a wax equipped with a transformable functional group, such as carboxylic acid or hydroxyl. In embodiments, suitable examples of curable waxes may include hydroxyl, terminated polyethylene waxes, carboxylic acid-terminated polyethylene waxes

The UV curable varnish may contain other optional additives. Optional additives include surfactants, light stabilizers, UV absorbers, which absorb incident UV radiation and convert it to heat energy that is ultimately dissipated, antioxidants, optical brighteners, which can improve the appearance of the image and mask yellowing, thixotropic agents, dewetting agents, slip agents, foaming agents, antifoaming agents, flow agents, other non-curable waxes, oils, plasticizers, binders, electrical conductive agents, fungicides, bactericides, organic and/or inorganic filler particles, leveling agents, such, agents that create or reduce different gloss levels, pacifiers, antistatic agents, dispersants, and the like. In particular, the composition may include, as a stabilizer, a radical scavenger, such as Irgastab UV 10 (Ciba Specialty Chemicals, Inc.). The composition may also include an inhibitor, such as a hydroquinone, to stabilize the composition by prohibiting or, at least, delaying, polymerization of the oligomer and monomer components during storage, thus increasing the shelf life of the composition. However, additives may negatively affect cure rate, and thus care should be taken when formulating a composition using optional additives.

In embodiments, the optional additives may include an additive for assisting in the radiation curing of the composition. Suitable additives include BYK®-UV3510 (BYK Chemie GmbH), also known as polyether modified polydimethylsiloxane, BYK-348® (BYK Chemie GmbH) and mixtures thereof.

The total amount of other additives included in the UV curable varnish may be, for example, from about 0.1 to about 15%, such as from about 1 to about 10%, by weight of the UV curable varnish.

In embodiments, the UV curable varnish may undergo a radical curing technique. This means the UV curable varnish may be capable of absorbing UV radiation and producing free radicals that initiate free radical polymerization of the polymerizable compounds, causing the UV curable varnish to cure and harden.

The component of the UV curable varnish that usefully absorbs UV radiation is the photoinitiator. This absorption of a photon of light promotes an electron from a low energy orbital to a high energy orbital within the photoinitiator molecule. The molecule with an electron in a high energy orbital is in its excited state. From this excited state various pathways can be followed. There are three typical pathways that are useful to effecting cure of the WV curable varnish. All three pathways ultimately result in the production of a free radical that can react with the carbon-carbon double bond of the acrylate groups found in other UV curable varnish components.

The three pathways for the excited photoinitiator molecule are: (1) direct fragmentation via homolytic bond cleavage to produce at least one radical of sufficient energy to initiate acrylate polymerization, (2) a bimolecular reaction where the excited molecule attracts a hydrogen atom from another differently structured molecule and this second molecule initiates acrylate polymerization, and (3) the excited molecule transfers its energy to another differently structured molecule which then initiates polymerization.

The UV curable varnish compositions may be prepared by combining all of the ingredients, heating the mixture to at least its melting point, and stirring the mixture, for example from about 5 seconds to about 120 minutes or more, such as from 1 minute to 100 minutes or from about 30 minutes to about 90 minutes, to obtain a substantially homogeneous, uniform melt. When pigments are the selected colorants, the molten mixture may be subjected to grinding in an attritor or ball mill apparatus to effect dispersion of the pigment in the UV curable varnish. In embodiments, the UV curable varnish composition may be prepared by first combining the ingredients to form the varnish, and then adding a colorant to the mixture.

Curing of the UV curable varnish can be affected by exposure of the UV curable varnish to actinic radiation at any desired or effective wavelength, for example, from about 100 nanometers to about 600 nanometers, such as from about 150 nanometers to about 550 nanometers or from about 200 nanometers to about 480 nanometers, although the wavelength can be outside of these ranges. Exposure to actinic radiation can be for any desired or effective period of time, for example, from about 0.01 second to about 30 seconds, such as from about 0.01 second to about 15 seconds or from about 0.01 second to about 5 seconds. As used herein, “curing” refers to the curable compounds in the ink undergoing an increase in molecular weight upon exposure to actinic radiation, such as crosslinking, chain lengthening, or the like.

Additionally, curing of the ink using such UV radiation may cause the fluorescent component in the UV curable varnish to temporarily fluoresce and be visible upon exposure to the UV radiation. However, the image formed of the UV curable varnish having the fluorescent component will return to its non-fluorescent state within a reasonable time after the image is cured and no longer exposed to UV radiation. An advantage of this feature is that the fluorescent properties of the UV curable varnish may be verified during image formation without the need to verify or evaluate the image for fluorescence after the image has been formed.

A UV image detecting system may include, for example, a ready or verifying device. Such device provides the UV radiation to expose the image formed by or contained in the UV curable varnish and to cause the fluorescence. The device desirably includes a viewing area where a viewer can view the exposed UV curable varnish and see the fluorescence (or, in the case of a fake, not the lack of fluorescence). In embodiments, clear UV curable varnish may be written on a check to overcoat prior printed images (again, such as text or characters) thereon the check. The image cannot be identically copied because the copy will not include the fluorescent feature. When the check is illuminated with UV radiation, the UV curable varnish fluoresces the prior printed images having the UV curable varnish thereon. No such response is found in any copied versions, identifying the copies as fakes. In embodiments, the UV image detecting system may be a handheld UV lamp and the like.

In embodiments, the UV curable varnish may be digitally printed onto a document, such as a check, to overcoat pre-existing or prior printed images or one or more portions of the preexisting or prior printed images in specific locations such as, for example, a line on the check, a currency symbol, a signature or signature line on the check, and/or oil a price value of the check to form one or more security features associated with the check. When, for example, the check is illuminated with UV radiation, the fluorescent component of the UV curable varnish fluoresces and reveals the pre-existing or prior printed images of the check having UV curable varnish overcoating. Moreover, a viewer may identify the one or more fluorescing images of the check displayed via the fluorescing UV curable ink and may determine that the check is authentic. As a result of viewing the images fluorescing with the UV curable varnish, the viewer may determine whether the check is authentic, a fraud or a counterfeit by exposing the check or a portion of the check having the UV curable varnish to UV radiation.

Similar security aspects can be added to any document or product by overcoating a part or all of the text, characters, symbols, etc., of the document or product with the UV curable varnish in the same manner as detailed above.

Embodiments described above will now be further illustrated by way of the following examples.

### EXAMPLE 1

The following example illustrates dissolving a fluorescent component, such as a fluorescent dye into a UV curable varnish, overcoating the UV curable varnish onto a substrate, and curing the UV curable varnish with UV radiation.

200 mg of a fluorescent dye DFSB-C7 (Risk Reactor) was dissolved by sonication into 5 mL of an ink jettable overprint varnish comprising about 19% LAROMER® PO43F (BASF Corp.) (a low viscous, unsaturated polyether acrylate monomer), about 76% SR-9003 (Sartomer Co., Inc.) (a propoxylated-2-neopentyl glycol diacrylate or diacrylate cross-linking monomer), about 4.8% IRGACURE® 184 (CIBA-GEIGY Corp.) UV photoinitiator also known as 1-hydroxyclyclohexylphenyl ketone, and about 0.2% BYK®-UV3510 (BYK Chemie GmbH) surface additive for radiation curing also known as polyether modified polydimethylsiloxane. The solution was overcoated onto a print on a paper substrate (Xerox Digital Color Expressions Plus) by using a blade with a 5 mils gap (˜125 μm). Curing was performed by passing the print including the solution through a curing station from Fusion Systems Inc. to form the print with an overcoated UV curable varnish. An image of the overcoated UV curable varnish fluoresces with exposure of the substrate to UV radiation from a hand-held UV source. The high loading of fluorescent component in the UV curable varnish does not hinder the ability of the UV curable varnish to cure, even though the fluorescent component absorbs radiation in the UV range.

### EXAMPLE 2

A UV curable varnish containing fluorescent dye was obtained similarly to Example 1 and the solution was digitally overcoated onto a print on a paper substrate, such as DIGITAL COLOR EXPRESSIONS PLUS (Xerox) and cured by using a VARSTAR SHEETFED DIGITAL UV COATER (Pat Technology Systems INC.). An image of the overcoated UV curable varnish fluoresces with exposure of the substrate to UV radiation from a hand-held UV source.

The following example illustrates dissolving a fluorescent component, such as a fluorescent dye into a UV curable varnish, overcoating the UV curable varnish onto a substrate, and curing the UV curable varnish with UV radiation.

### EXAMPLE 3

About 200 mg of a fluorescent dye DFSB-C7 (Risk Reactor) was dissolved by sonication into about 5 mL of an ink jettable overprint varnish comprising about 94.78% BASF® PO94F (BASF Corp.), about 0.3% UV photoinitiator ethyl-2,4,6-trimethylbenzoylphenylphosphinate (LUCIRIN® TPO-L (BASF Corp.)), about 0.05% surfactant polyether modified polydimethylsiloxane (BYK-UV3510® (BYK Chemie GmbH)), about 0.05% BYK-348® (BYK Chemie GmbH), and about 4.82% UV photoinitiator 1-hydroxyclyclohexylphenyl ketone (IRGACURE® 184 (CIBA-GEIGY Corp.)). The solution was digitally overcoated onto a print on a paper substrate, such as DIGITAL COLOR EXPRESSIONS PLUS (Xerox) by using a VARSTAR SHEETFED DIGITAL UV COATER (Pat Technology Systems Inc.) to form the print with an overcoated UV curable varnish. An image of the overcoated UV curable varnish fluoresces with exposure of the substrate to UV radiation from a hand-held UV source.

### EXAMPLE 4

About 200 mg of a fluorescent dye DFSB-C7 (Risk Reactor) was dissolved by sonication into about 5 mL of an ink jettable overprint varnish comprising about 23.0% Amine Modified Polyester Tetracrylate EB80 (Cytec Surface Specialties), about 68.9% Amine Modified Polyester Acrylate EB81 (Cytec Surface Specialties), about 4.8% UW photoinitiator 1-hydroxyclyclohexylphenyl ketone (IRGACURE® 184 (Ciba-Geigy Corp.)), about 0.3% UV photoinitiator ethyl-2,4,6-trimethylbenzoylphenylphosphinate (LUCMRIN® TPO-L (BASF Corp.)), and about 3.0% surfactant polyether modified polyditnethylsiloxane (BYK®-UV3510 (BYK Chemie GmbH)). The mixture was stirred at room temperature for at least two hours at high shear until the U photoinitiator fully dissolved. The solution was digitally overcoated onto a print on a paper substrate, such as DIGITAL COLOR EXPRESSIONS PLUS (Xerox) by using a VARSTAR SHEETFED DIGITAL UV COATER (Pat Technology Systems Inc.) to form the print with an overcoated UV curable varnish. An image of the overcoated UV curable varnish fluoresces with exposure of the substrate to UV radiation from a hand-held UV source.

The UV curable varnish is digitally printed to existing text of a document to overcoat the existing text with the UV curable varnish. The existing text overcoated with the UV curable varnish is exposed to radiation in the UV spectrum in a wavelength range from about 100 nm to about 400 nm to fluoresce the UV curable varnish. The UV curable varnish having the fluorescent component fluoresces and the UV curable varnish overcoating the existing text of the document is realized by a user. As a result, the user may authenticate the document by viewing the fluorescing UV curable varnish overprinted on the existing text of the document.

It will be appreciated that various of the above-disclosed and other features and functions, or alternatives thereof, may be desirably combined into many other different systems or applications. Also, it will be appreciated that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A method for applying varnish to a document, the method comprising:
providing an ultraviolet radiation curable fluorescent varnish comprising at least one curable monomer or oligomer, at least one photoinitiator, and at least one fluorescent material, wherein upon exposure to activating radiation, the fluorescent material fluoresces to cause a visible change in the appearance of the ultraviolet radiation curable fluorescent varnish;
determining a location of printed portions of an image on a substrate; and
digitally printing the ultraviolet radiation curable fluorescent varnish onto the substrate in image registration only upon one or more portions of the determined printed portions on the substrate.

2. The method according to claim 1, wherein the ultraviolet radiation curable fluorescent varnish is substantially colorless when not exposed to the activating radiation.

3. The method according to claim 1, further comprising:
curing the ultraviolet radiation curable fluorescent varnish on the surface of the substrate via ultraviolet radiation.

4. The method according to claim 1, wherein the ultraviolet radiation curable fluorescent varnish on the surface of the substrate exhibits a gloss that substantially matches a gloss of the determined printed portions of the image on the substrate.

5. The method according to claim 1, further comprising:
displaying authentication information formed by the ultraviolet radiation curable fluorescent varnish on the surface of the substrate by exposing the ultraviolet radiation curable fluorescent varnish to the activating radiation.

6. The method according to claim 1, wherein the activating radiation has a wavelength in a range from about 100 nm to about 400 nm.

7. The method according to claim 1, wherein the fluorescent material is selected from the group consisting of rhodamines, fluoresciens, coumarins, napthalimide, benzoxanthenes, acridines, quantum dots and mixtures thereof.

8. The method according to claim 1, wherein the at least one curable monomer or oligomer is selected from the group consisting of propoxylated neopentyl glycol diacrylate, diethylene glycol diacrylate, triethylene glycol diacrylate, hexanediol diacrylate, dipropyleneglycol diacrylate, tripropylene glycol diacrylate, alkoxylated neopentyl glycol diacrylate, isodecyl acrylate, tridecyl acrylate, isobomyl acrylate, propoxylated trimethylolpropane triacrylate, ethoxylated trimethiylolpropane triacrylate, di-trimethylolpropane tetracarylate, dipentaerythritol pentacarylate, ethoxylated pentaerythritol tetraacrylate, isobomyl methacrylate, lauryl acrylate, lauryl methacrylate, isodecylmethacrylate, caprolactone acrylate, 2-phenoxyethyl acrylate, isooctylacrylate, isooctylmethacrylate, butyl acrylate, oligomeric acrylates and mixtures thereof.

9. A method for applying varnish to a document, the method comprising:
providing an ultraviolet radiation curable fluorescent varnish comprising at least one curable monomer or oligomer, at least one photoinitiator, and at least one fluorescent material, wherein upon exposure to activating radiation, the fluorescent material fluoresces to cause a visible change in the appearance of the ultraviolet radiation curable fluorescent varnish;
determining a location of printed portions of an image on a substrate based on information, wherein the location of the printed portions of the image is determined based on printing information for the image on the substrate, information from copying the image on the substrate or information from scanning the substrate; and
digitally printing the ultraviolet radiation curable fluorescent varnish onto the substrate in image registration only upon one or more portions of the determined printed portions on the substrate.

10. The method according to claim 9, wherein the ultraviolet radiation curable fluorescent vanish is substantially colorless when not exposed to the activating radiation.

11. The method according to claim 9, wherein the ultraviolet radiation curable fluorescent varnish exhibits a color in ambient light and a same or different color when fluorescing upon exposure to the activating radiation.

12. The method according to claim 9, further comprising:
authenticating the document by exposing the surface of the document to the activating energy and fluorescing the ultraviolet radiation curable fluorescent varnish on the detected image on the substrate.

13. The method according to claim 9, wherein the fluorescent material is selected from the group consisting of rhodamines, fluoresciens, coumarins, napthalimide, benzoxanthenes, acridines, quantum dots and mixtures thereof.

14. The method according to claim 9 wherein the activating radiation has a wavelength in a range from about 100 nm to about 400 nm.

15. A method for authenticating a document, the method comprising:
forming the document by forming an image on a surface of a substrate, determining location of printed portions of the image on a substrate, and applying and curing an ultraviolet radiation curable fluorescent varnish onto the substrate in image registration only upon one or more portions of the detected image on the substrate, the ultraviolet radiation curable fluorescent varnish comprising at least one curable monomer or oligomer, at least one photoinitiator, and at least one fluorescent material, wherein upon exposure to activating radiation, the fluorescent material fluoresces to cause a visible change in the appearance of the ultraviolet radiation curable fluorescent varnish; and
exposing the document to the activating radiation, wherein the document is determined to be authentic if the exposing results in fluorescing of the ultraviolet radiation curable fluorescent varnish at the overcoated locations.

16. The method according to claim 15, wherein the activating radiation has a wavelength in a range from about 100 nm to about 400 nm.

17. The method according to claim 15, wherein the radiation curable fluorescent varnish is substantially colorless when not exposed to the activating radiation.

18. The method according to claim 15, wherein the radiation curable fluorescent varnish exhibits a color in ambient light and a same or different color when fluorescing upon exposure to the activating radiation.

19. The method according to claim 15, wherein the ultraviolet radiation curable fluorescent varnish on the surface of the substrate exhibits a gloss that substantially matches a gloss of the determined printed portions of the image on the substrate.

20. The method according to claim 15, wherein the fluorescent material is selected from the group consisting of rhodamines, fluoresciens, coumarins, napthalimide, benzoxanthenes, acridines, quantum dots and mixtures thereof.
